(19) United States
(12) Patent Application Publication
(10) Pub. No.: US 2010/0160057 A1
(43) Pub. Date: Jun. 24, 2010

(54) Illuminated Flagpole

(76) Inventor: Richard Willett, New York, NY (US)

Correspondence Address: CROSSLEY PATENT LAW, 236 South Third Street, #287, MONTROSE, CO, 81401, US

(21) Appl. No.: 11/992,466

(22) PCT Filed: Sep. 27, 2006
(86) PCT No.: PCT/US06/37969

§ 371 Date: Mar. 20, 2008

Related U.S. Application Data
(60) Provisional application No. 60/721,561, filed on Sep. 28, 2005.

(51) Int. Cl. A63B 57/00; H05B 37/02; F21L 4/00; G01S 19/19

(52) U.S. Cl. 473/176; 315/362; 362/183; 342/357.09

(57) ABSTRACT

An illuminated golf flagpole is disclosed. One embodiment comprises a frosted polycarbonate tube coated or continuous covering with electoluminescent film. Another embodiment provides a plurality of LEDs externally mounted to a flagpole tube and covered with a translucent shell. Yet another embodiment provides a range finder mounted to a flagpole tube for transmitting data to a golfer via a portable remote control device or GPS receiver regarding such golfer's distance from a flagpole pin. Luminescence levels and colors may be adjusted to meet golf association and course rules and provide data regarding distance from a flagpole pin. Still yet another embodiment provides an anemometer and a wind direction detector mounted to a flagpole tube to transmit information about wind direction and speed at the pin to the golfer at each hole using such remote control device or remote receiver.

### SUMMARY OF THE INVENTION

This unique device is designed for the purpose of providing an internally or externally illuminated golf flagpole. Currently, the golf industry uses conventional, non-lighted flagpoles to mark the location of holes on golf course greens. Flagpoles assist a golfer in determining the distance from a golfer's golf ball to a hole on a green. Flagpoles also assist a golfer in determining which golf club to use in making a shot onto a green. Conventional golf flagpoles are often difficult for a golfer to see for several reasons. Environmental backdrops often create problems for being able to see a golf flagpole. For example, conventional golf flagpoles are vertical and may be somewhat thin compared to other objects either on the golf course or in the viewing background. For instance, fences or buildings having vertical structural lines which perceptually run parallel to a golf flagpole and, which lie in the background, behind a golf flagpole, may cause a golf flagpole to practically disappear from golfer's view from a perceptual standpoint. The light coloring of conventional golf flagpoles also presents a challenge in being able to see such golf flagpoles. Certain weather conditions, such as rain or clouds, may make golf flagpole viewing tricky. Low lighting conditions, such as occur near dusk or dawn, may also impede a golfer's ability to see a golf flagpole. However, certain aspects of the present illuminated golf flagpole may overcome one or more drawbacks of the previous art and advance the state-of-the-art of golf flagpoles and, in addition, may meet one of more of the objects as stated hereinbelow.

To overcome the aforestated disadvantages of conventional flagpoles, the current invention is designed to provide an illuminated golf flagpole. One embodiment of the present invention comprises a frosted polycarbonate tube coated or continuous covering with electroluminescent film. Said tube forms the basis for a flagpole assembly. Other suitable translucent materials, such as PVC or HDPE, may be used to construct said tube. Some materials for construction of said tube may be better than others depending upon the cost and environmental conditions in which the invention may be used. For example, HDPE may be better for tube construction than PVC since PVC tends to bend more readily and to bend over farther than HDPE. Electroluminescent film is employed in the present invention to provide a luminescence to a golf flagpole when said flagpole is connected to a power source. Said power source may take one of several forms. For instance, said power source may be in the form of a wired remote power source, such as a rechargeable battery located near a golf cup hole on a golf course green hard wired to such golf flagpole located within said golf cup. Said power source may also be in the form of a recharageable internal (or on board) source, such as a rechargeable battery located within said golf cup and hard-wired to a milled metal stem providing power to said golf flagpole when said golf flagpole makes a connection with said milled stem. Another power source may be a solar power cell located on said golf flagpole. Said power source may also be a remote radio wave or wireless power system.

Luminescence temporarily ceases when an illuminated golf flagpole is removed from a golf cup and returns upon returning said golf flagpole to a golf cup. The level of luminescence in one embodiment is designed to conform to golf rules for golf associations in the United States, such as the United States Professional Golf Association, as well as golf rules throughout the world. In alternative embodiments, luminescence levels for a golf flagpole may be adjusted for various distances from a golf ball position on a fairway or in a rough to a golf hole on a green. Furthermore, alternative embodiments would allow for various luminescent golf flagpole colors. The aforestated alternative embodiments would be useful on public and private golf course greens and golf driving ranges. Yet another embodiment of the present illuminated golf flagpole provides a rangefinder or GPS system mounted to a flagpole tube, as well as a portable remote control device for such rangefinder or GPS system, to determine distance from each hole to actual golfer location. In addition, an anemometer is mounted to said flagpole tube to transmit information about wind direction and speed at the pin to the golfer at each hole using such remote control device. There are, of course, additional features of said device which will be described hereinafter.

Numerous objects, features, and advantages of said apparatus will be readily apparent to those of ordinary skill in the art upon reading the following detailed description of presently preferred, but nonetheless illustrative, examples of the present device when taken in conjunction with the accompanying drawings. In this respect, before explaining the current examples of said device in detail, it is to be understood that said apparatus is not limited in its application to the details of construction and arrangements of the components set forth in the following description or illustration. Said device is capable of other examples and of being practiced and carried in various ways. It is also to be understood that the phraseology and terminology employed herein are for purposes of description and should be regarded as limiting.

Those skilled in the art will appreciate that the conception upon which this disclosure is based may readily be utilized as a basis for the design of other structures, methods, and systems for carrying out the several purposes of the device. It is therefore important that the description be regarded as including such equivalent constructions insofar as they do not depart form the spirit and scope of the present device.

An object of the present device is to provide an illuminated golf flagpole where none previously exists.

Another object is to provide a device to assist golfers in being able to more easily and accurately locate a hole on a golf course green by use of the present device as compared with use of a conventional golf flagpole.

Yet another object of this device is to provide for better golf hole location in adverse weather conditions, such as while playing golf in a rainy or cloudy environment.

Still another object of the illuminated golf flagpole is to provide color-coded lighting of the flagpole, thereby identifying flagpole location on the green.

With this device, a golf hole may be more easily and accurately located in low lighting conditions, such as at dusk or dawn than with conventional unlighted golf flagpoles.

As compared with a conventional golf flagpole, the present illuminated golf flagpole can be seen more easily against various environmental backdrops, permitting easier and more accurate location of a hole on a golf green.

### ADVANTAGES

One advantage of the present device over prior art is that it is a uniquely designed device for illuminating a golf flagpole. This device is also in concert with the current trend in the golf industry to use PVC or HDPE golf cup inserts in a golf hole, rather than metal cup inserts. This device encourages the use of PVC or HDPE golf cup inserts, rather than metal cup inserts, making it environmentally friendly since metal cup inserts must be replaced about every two years. Millions of metal cup inserts are discarded into solid waste disposal facilities creating environmental and disposal problems.

A huge advantage of the present device is that the device would encourage golfers to play in various adverse conditions, such as in rainy weather, on a cloudy day, or at or near dusk or dawn, when locating a golf hole by use of a conventional golf flagpole is more difficult. By allowing easier location of a golf hole under these adverse conditions and thereby encouraging more golf play during these conditions, time for golf play is conveniently extended for the working sector of golf players and as an additional benefit, such extended play time relieves often overcrowded golf courses by providing more tee times.

A further advantage is greater income to the golf course, as course play time is extended to cover less than optimal conditions.

Additionally, the color-coded illumination option of the present flagpole can negate the cost of colored flags now used to locate the pin for golfers, with differing colors signifying fore, mid-green, and aft locations of the pin.

Another advantage over prior art is that this device would assist golfers with vision problems or sight disabilities, such as senior golfers, to more easily and accurately locate golf holes, also making a golf game more enjoyable for those with such disadvantages.

Additional advantages of the present apparatus may become apparent upon referring to the preferred and alternative embodiments of the present apparatus as illustrated in the drawings and described in the following written description.

### DRAWINGS—FIGURES

FIG. 1 is a section elevation of a golf cup, golf flagpole and golf flag assembly of the present invention.

FIG. 2a is a side elevation view of a golf cup, flagpole tube, electroluminescent film and milled aluminum stem.

FIG. 2b is an exploded side elevation view of FIG. 2a illustrating a milled aluminum stem, flagpole tube, and wire leads located within golf cup.

FIG. 2c is a bottom plan view of a golf cup illustrating a milled aluminum stem located within said golf cup.

FIG. 3a is a side elevation view of electroluminescent film illustrating positive, negative and common charges running through said film.

FIG. 3b is a schematic diagram illustrating connection of a power source to and provision of input voltage to electroluminescent film via 12 volt golf cart battery and a timer.

FIG. 3c is a cross-sectional view of a golf flagpole illustrating positioning of flagpole tubing and electroluminescent film.

FIG. 4a is a side elevation view of a top section of a golf flagpole illustrating a milled aluminum cap.

FIG. 4b is a front view of a milled aluminum cap illustrating branding.

FIG. 4c is a perspective view of a milled aluminum cap.

FIG. 5 is a front view illustrating an embodiment featuring a solar power cell as a power source with a rechargeable battery located inside a golf cup.

FIG. 6 is a side elevation view of an alternative embodiment illustrating LEDs mounted to a flagpole tube and covered by a translucent shell.

FIG. 7 is a cross-sectional side elevation view of an alternative embodiment illustrating flagpole tube having an internal transmitter and tilt switch and an external female power socket.

FIG. 8 is a cross-sectional side elevation view of an alternative embodiment illustrating a flagpole tube having internally stored rechargeable cadmium batteries.

FIG. 9a is an isometric view of an alternative embodiment of an illuminated golf flagpole illustrating operation by a remote control device shown in FIG. 9b.

FIG. 9b is an isometric view of a remote control device for operation of illuminated golf flagpole as illustrated in FIG. 9a.

FIG. 9c is a side elevation view of an alternative embodiment of an illuminated golf flagpole illustrated in FIG. 9a.

FIG. 10a is an isometric view of an alternative embodiment of an illuminated golf flagpole having an anemometer shown in FIG. 10b mounted to a flagpole tube.

FIG. 10b is an isometric view of an anemometer mounted to an illuminated golf flagpole as shown in FIG. 10a.

### DRAWINGS—REFERENCE NUMERALS

10—the invention

20—flagpole tube

25—flag assembly

26—flag

30—electroluminescent film

40—golf cup insert

50—milled aluminum stem

60—golf cup insert support piece

70—cable

75—solar power cell

80—rechargeable battery

90—timer

100—wiring

110—input voltage primary

120—driver and cut-off circuit

130—housing

131—hinge

132—door

140—wire leads

150—common charged wiring

160—negative charged wiring

170—positive charged wiring

180—connector point

190—milled aluminum cap

200—tapped L-bolt

204—adapter

205—flagpole pin

206—distal end

207—lower end

208—upper end

210—LED

220—shell

225—upper covering

230—female power socket

240—range finder

250—tilt switch

260—rechargeable nickel-cadmium battery

270—remote control device

280—anemometer

290—wind direction detector

### DETAILED DESCRIPTION OF THE DRAWINGS

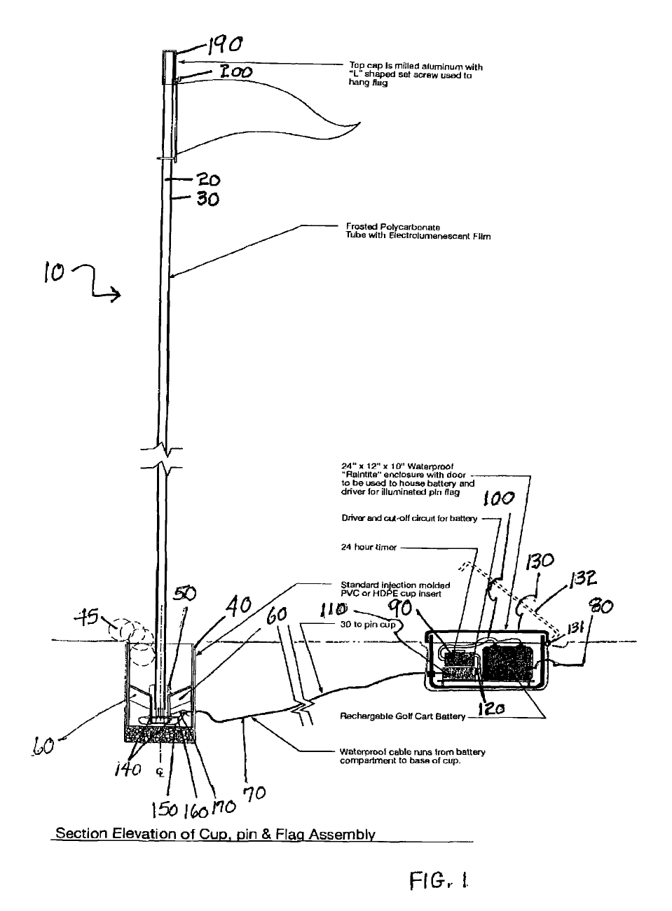

With reference now to the drawings, and in particular FIGS. 1 through 10b thereof, the principles and concepts of the present apparatus generally designated by the reference number 10 will be described.

FIG. 1 is a section elevation of a golf cup, golf flagpole and flag assembly of the present invention 10. A flagpole tube 20 formed of frosted polycarbonate is illustrated. Other suitable translucent materials, such as PVC or HDPE, may be used to construct said tube. Said flagpole tube 20 is formed to standard US Golf Association dimensions with respect to the standard interior clearance dimensions of a metal stick base and a diameter of the flagpole and the overall height and acceptance of Regulation Golf Green Flags. The interior surface of said flagpole tube 20 is coated or covered with thin layer of electroluminescent film 30 using a frost diffusion film or material or by abrading the interior surface to achieve frosting which serves to diffuse and make visually consistent illumination along the entire length of said flagpole tube 20. Light-emitting phosphor, for example, may be applied to a thin layer of film or like material and placed between two thin electrodes. One is opaque and the other is translucent to allow light to escape. The brightness and color of the light depends upon the chemical composition and dye pigments of the phosphor. Said flagpole tube 20 is formed to a width to allow a golf ball 40 (not part of the present invention) to fall into a golf cup insert 40. Said flagpole tube 20, which is held in place vertically by and within a center of a golf cup insert 40, is fabricated so as to include three conductors (common charged wiring 150; negative charged wiring 160; and positive charged wiring 170) arranged at various elevations of a based overall length. These conductive elements correlate to the power conductors similarly oriented in a modified standard golf cup insert 40. Power is introduced and conducted into a flagpole tube 20 whenever a golf flagpole tube 20 is inserted into a modified golf cup insert 40 described hereinbelow.

A modified standard injection molded PVC or HDPE golf cup insert 40 is shown positioned in a golf hole on a golf course green. Such golf cup insert 40 is fitted with three permanent wires and conductors (common charged wiring 150; negative charged wiring 160; and positive charged wiring 170), which are placed in the interior clear cylinder hole which accepts and holds a metal based of a flagpole tube 20. The three conductors are located at varying elevations inside the cylinder hole. This allows the system to operate by allowing the flagpole tube 20 to illuminate even when water exists in the golf cup insert 40 as long as one conductor is not immersed in water. When all conductors are immersed in water, the invention 10 shuts down automatically and must be reset at the power source. Three conductor wires attach to three power source wires via three silicone impregnated waterproof wire leads 140 located just outside the perimeter of a golf cup in the ground surrounding a golf cup. A milled aluminum stem 50 is held into place in a center of a golf cup insert 40 by a plurality of golf cup insert support piece 60. Said milled aluminum stem 50 has a hollow center sufficiently wide to allow said flagpole tube 20 to snuggly fit vertically into said milled aluminum stern 50. A rechargeable battery 80, such as a standard golf cart battery, provides power to operate said invention 10. From said rechargeable battery 80 is wiring 100 from said rechargeable battery 80 to a timer 90. Said timer 90 could be a 24-hour timer which could be used to turn battery power on or off as desired. A driver and cut-off circuit 120 for said rechargeable battery 80 runs from said timer 90 to input voltage primary 110. Said driver and cut-off circuit 120 contains a fused or breakered shut off to protect the components in the event of any short circuit. A waterproof housing 130, such as a “Raintite” enclosure, houses said rechargeable battery 80, timer 90, driver and cut-off circuit 100, input voltage primary 110 and all wiring between these components. Input voltage primary 110 could be low voltage in a range, for example, between 12 to 24 volts DC with a current or amperage maximum of 10 watts. The low voltage and amperage could prevent the possibility of electrocution. Such power levels are commonly referred to as Class 2 Low Voltage, which has been a standard for incandescent low voltage exterior illumination. Said housing 130 is placed slightly below grade and is topped with a door 132, which is grade level. Said door 132 is has a hinge 131 to allow opening said door 132 for removal or replacement of components housed within said housing 130. Said housing 130 could be located just off of a putting green. A waterproof cable 70 runs from said input voltage primary 110 through the wall of said golf cup insert 40. Inside said golf cup insert 40 where said cable 70 enters said golf cup insert 40 are common charged wiring 150, negative charged wiring 160 and positive charged wiring 170, that make an electrical connection with aluminum milled stem 50, providing power to illuminate said flagpole tube 20 covered with said electroluminescent film 30. Below said golf cup insert 40 is fitted a clear encapsulated waterproof lighting element which: a) converts input power from the power source through power conversion inverter components and heat sink for heat removal, similarly encapsulated or co-encapsulated with the light source and a pre-focused lens component and b) powers or illuminates a low wattage high output lighting device. Multiple 2-wire sets comprised of common charged wiring 150, negative charged wiring and positive charged wiring 170 could be run from rechargeable battery 80 to various locations any where on a putting green to allow and facilitate the moving of a golf flagpole to various locations on a putting green provided, however, that only one set of 3 wires could be connected to rechargeable battery 80 at any given time. In an alternative embodiment, multiple 2-wire sets may be run from the power source to various locations any where on the green to allow and facilitate the moving of the golf cup insert 40 to various locations on the green; however, only one set of three wires would be used to connect the power source at any given time. The set of wire to be used would be determined by the desired location of a flagpole tube 20. In other words, there is an individual set of three wires for each flagpole tube location desired. Said flagpole tube 20 is capped with a top cap 190 comprising a machined cylinder formed of milled aluminum and open-ended on the bottom end to fit over said flagpole tube 20. On an open-ended bottom of top cap 190 is a tapped L-bolt 200 set screw used to secure top cap to flagpole tube 20 and to hang a golf flag. Said top cap 190 is machined through leaving an exposed face with a corporate logo, graphic, promotional icon, and other similar decoration or emblem. Light from an electroluminescent film 30 reflects through a machined decoration, emblem, logo or the like, providing backlighting. In an alternative embodiment, top cap 190 could be replaced with a solar power cell 75 (shown in FIG. 5) to comprise a power source for said invention 10 or a solar power cell 75 could be placed above said top cap 190 (as shown in FIG. 5). A connector between a solar power cell 75 (shown in FIG. 5) could be run inside a flagpole tube 20 to a driver and cut-off circuit 120 which could regulate the amount of power received and send excess electricity to a rechargeable battery 80. A timer 90 could be a 24-hour timer which could be used to turn battery power on or off as desired. Thus, power from rechargeable battery 80 could be used to operate invention 10 on cloudy days, for instance. A rechargeable battery 80 could be attached to and below a golf cup insert 40 in each golf cup hole to allow for moving a golf flagpole to various locations on a golf green. A connector from a rechargeable battery 80 to electroluminescent film 30 could comprise a power source to cause said electroluminescent film 30 to illuminate.

In another alternative embodiment, a flagpole tube 20 could be illuminated via a remote radio wave power system or wireless power system. Said flagpole tube 20 could also be externally illuminated or internally illuminated.

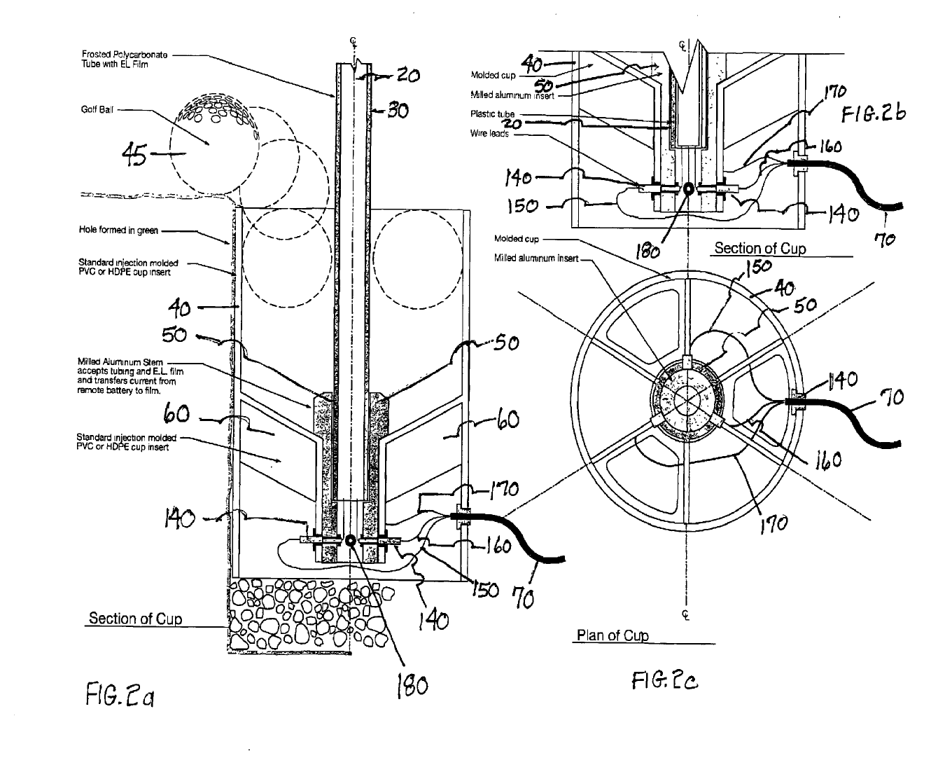

FIG. 2a is a side elevation view of a golf cup insert 40 into which is fitted a milled aluminum stem 50 (also may be referred to as an inverter) which accepts said flagpole tube 20 coated with electroluminescent film 30 and transfers current, illustrated as common charged wiring 150, negative charged wiring 160 and positive charged wiring 170, from a rechargeable battery 80 (shown in FIG. 1) via lead wires 140 running out of a cable 70. When lead wires 140 meet at a connector point 180 and flagpole tube 20 (shown in FIGS. 1 and 2a) coated with electroluminescent film 30 (shown in FIGS. 1 and 2a) is properly in place, said flagpole tube 20 (shown in FIGS. 1 and 2a) becomes illuminated.

Referring now to FIG. 2b an exploded side elevation is shown of FIG. 2a illustrating flagpole tube 20 inserted into a milled aluminum insert 50 seated in a golf cup insert 40. FIG. 2b shows flagpole tube 20 making contact wire leads 140 located within golf cup insert 40. At a point where cable 70 runs from a rechargeable battery 80 (shown in FIG. 1) into said golf cup insert 40 current from common charged wiring 150, negative charged wiring 160 and positive charged wiring 170 runs into said wire leads 140. Connector point 180 is a point at which wire leads 140 may join and thereby illuminate said flagpole tube 20 (shown in FIGS. 1 and 2a).

FIG. 2c is a bottom plan view of a golf cup insert 40 illustrating connection of current running from cable 70 to common charged wiring 150, negative charged wiring 160 and positive charged wiring 170 to a milled aluminum stem 50 located within said golf cup insert 40.

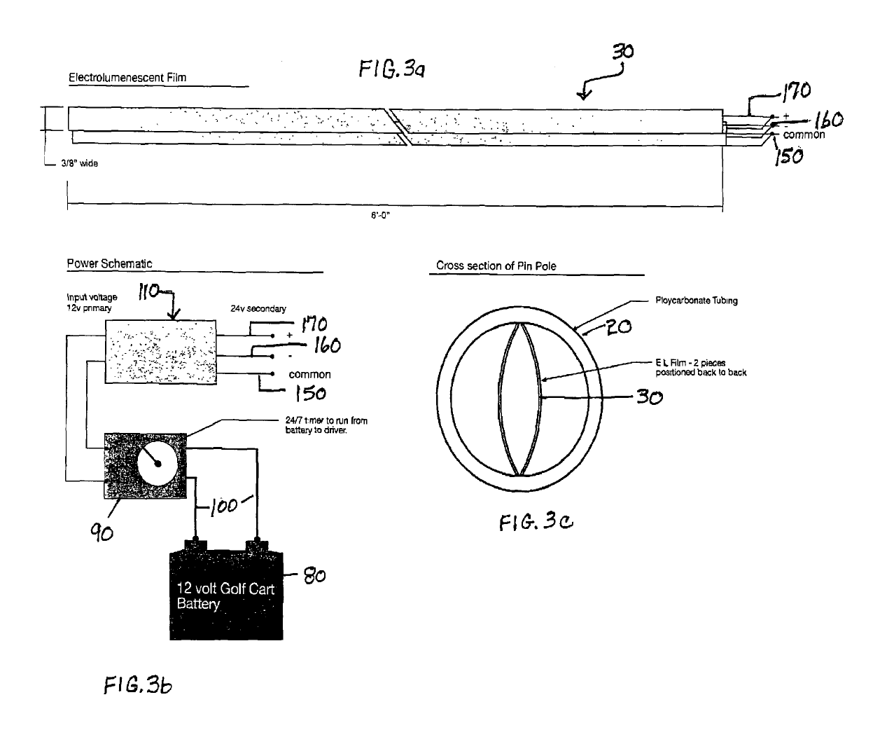

FIG. 3a is a side elevation view of electroluminescent film 30 illustrating positive charged wiring 170, negative charged wiring 160 and common charged wiring 150 making connection with said electroluminescent film 30.

FIG. 3b is a power schematic illustrating provision of a power source for said invention 10. A rechargeable battery 80, such as a 12-volt golf cart battery, provides a source of power via driver and cut-off circuit 100 through a timer 90, from said timer 90 to input voltage twelve-volt primary 110 source with output of a twenty-four volt secondary as common charged wiring 150, negative charged wiring 160 and positive charged wiring 170.

FIG. 3c is a cross-sectional view of a golf flagpole illustrating positioning of flagpole tube 20 and electroluminescent film 30 with two pieces of electroluminescent film 30 back to back.

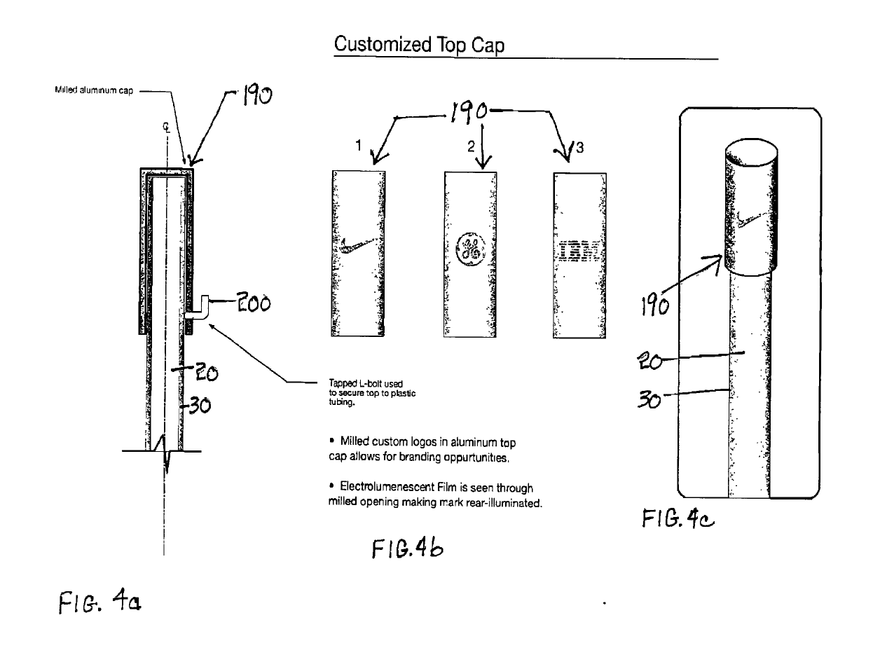

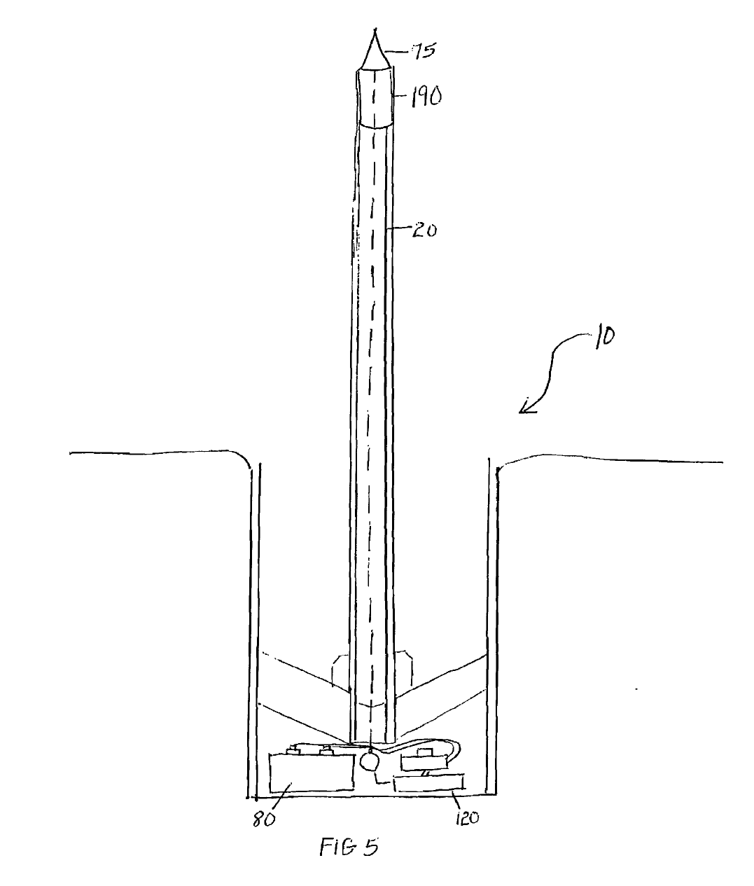

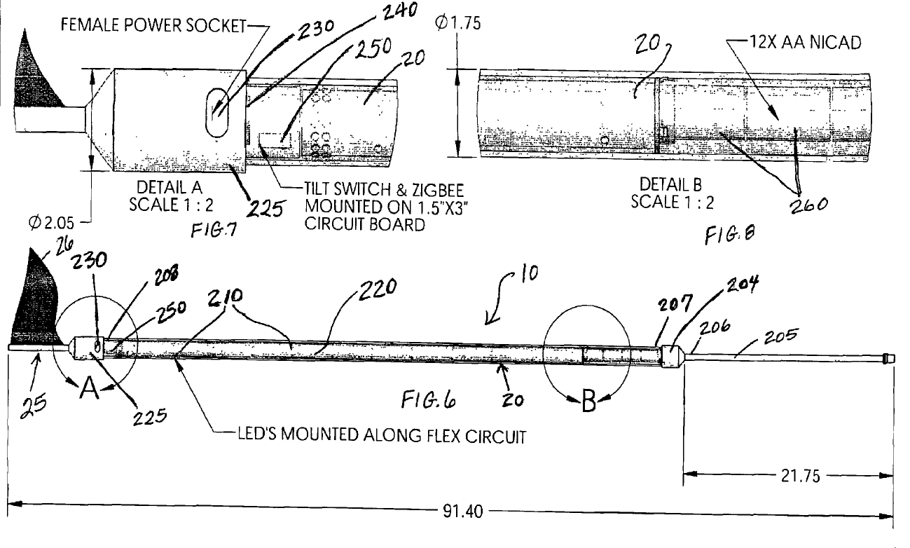

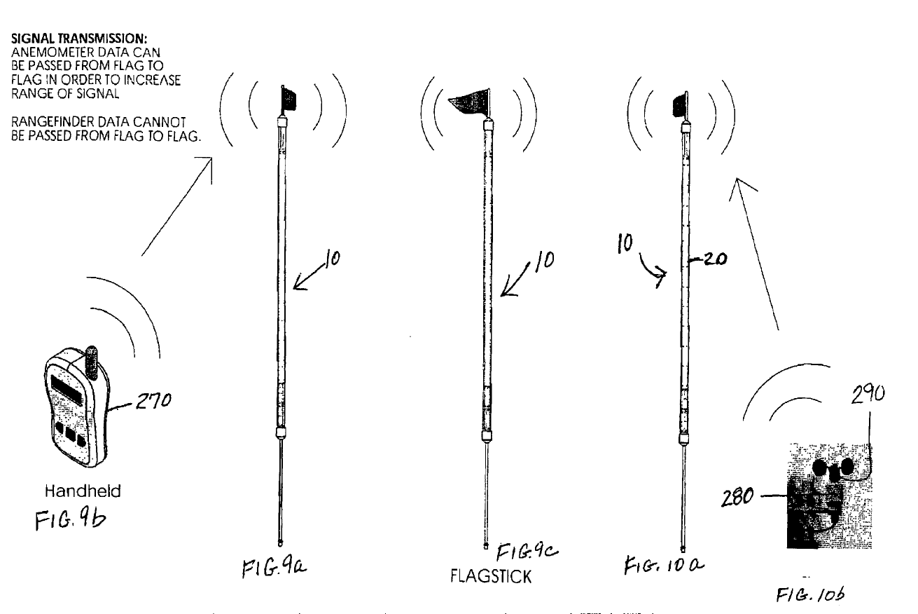

FIG. 4a shows a side elevation view of a top section of a golf flagpole tube 20 coated with electroluminescent film 30 capped by an U-shaped milled aluminum cap 190 which allows for advertising with branding as shown in FIG. 4b. One end of a tapped L-bolt 200 set screw is attached to one side of said U-shaped milled aluminum cap 190 with the other end of said tapped L-bolt 200 lying parallel to said flagpole tube 20 and pointing upwards.

FIG. 4b is a front view of a milled aluminum cap 190 illustrating various branding possibilities wherein a mark branded on said milled aluminum cap 190 is rear illuminated with electroluminescent film 30.

FIG. 4c is a perspective view of a milled aluminum cap 190 capping the top of said flagpole tube 20 coated with electroluminescent film 30.

FIG. 5 is a front view of invention 10 illustrating an embodiment featuring a solar power cell 75 as a power source with a rechargeable battery 80 located inside a golf cup.

### Alternative Embodiments

An alternative embodiment of the present device 10 envisions a smaller or “mini” version for use on a golf course putting green. The present device 10 may also be altered for use on a golf course driving range placing said illuminated golf flagpoles 10 at yardage intervals with various colors of illumination corresponding to designated yardage intervals.

In an alternative embodiment, top cap 190 could be replaced with a solar power cell 75 (shown in FIG. 5) to comprise a power source for said invention 10 or a solar power cell 75 could be placed above said top cap 190 (as shown in FIG. 5). A connector between a solar power cell 75 (shown in FIG. 5) could be run inside a flagpole tube 20 to a driver and cut-off circuit 120 which could regulate the amount of power received and send excess electricity to a rechargeable battery 80. A timer 90 could be a 24-hour timer used to turn battery power on or off as desired. Thus, power from rechargeable battery 80 could be used to operate invention 10 on cloudy days, for instance. A rechargeable battery 80 could be attached to and below a golf cup insert 40 in each golf cup hole to allow for moving a golf flagpole to various locations on a golf green. A connector from a rechargeable battery 80 to electroluminescent film 30 could comprise a power source to cause said electroluminescent film 30 to illuminate.

In another alternative embodiment, a flagpole tube 20 could be illuminated via a remote radio wave power system or wireless power system. Said flagpole tube 20 could also be externally illuminated or internally illuminated.

Yet another embodiment of an illuminated golf flagpole 10 is illustrated by FIGS. 6 through 10b. FIG. 6 illustrates a flagpole tube 20 removably mounted to a distal end 206 of a flagpole pin 205 via an adapter 204. Said flagpole tube may be formed of fiberglass or other suitable materials. FIG. 6 further illustrates a plurality of LED 210 externally mounted to a flagpole tube 20. Said adapter is formed to fit around said flagpole tube 20 at one end and to fit over said flagpole pin 205 at an opposite end. Said LEDs 210 are spaced apart vertically along said flagpole tube 20. Said LEDs 210 are preferably provided to blink at a frequency rate of 1 blink per 0.15 seconds duration per 1 second. In addition, LEDs 210 preferably blink simultaneously without sequential blinking. However, other blink frequency rates and patterns may be provided so as to provide optimal illumination depending upon various conditions. Further, said LEDs 210 are covered by a translucent durable shell 220. Said translucent shell 220 protects LEDs 210 from environmental elements and assists in the dispersion of light provided by such LEDs 210. A plurality rechargeable nickel-cadmium battery 260 internally stored on the lower end 207 of the flagpole tube 20 as shown in FIG. 8 provide a power source for operation of LEDs 210, as well as a range finder 240 shown in FIG. 7. Other types of rechargeable batteries, which provide sufficient power and are of a size to be internally stored within said flagpole tube 20, may be used in the place of rechargeable nickel-cadmium batteries 260. Sufficient power from said batteries should be provided so as to enable a user to recharge batteries at night, using an external charger, such as a 120-Volt AC charger.

An upper housing 225, illustrated in FIG. 6, is formed of a lightweight durable material fits around an upper end 208 of said flagpole tube 20 below a flag assembly 25, comprising a flag 26. A female power socket 230 is built into said upper housing 225 as shown in FIG. 6 and FIG. 7. Said female power socket 230 may be used to connect to a power source for recharging said rechargeable nickel-cadmium batteries 260. A tilt switch 250 is built into said upper end 208 of said flagpole tube 20. Said tilt switch 250 disconnects power to conserve power when said flagpole tube is removed from said flagpole pin 205. Said tilt switch 250 may comprise a small mercury or ball tilt toggle switch.

A range finder 240, comprising a GPS transmitter, is mounted to said upper end 208 of said flagpole tube 20 as shown in FIG. 6 and FIG. 7. Said range finder 240 transmits data, such as the distance of a golfer from a golf hole pin, to a golfer using a portable remote control device 270, which comprises a GPS receiver and a remote receiver, as shown in FIGS. 9a, 9b, and 9c. Said range finder 240 provides data regarding each specific hole and uses a different frequency for each hole to transmit data to a remote control device 270, as illustrated in FIGS. 9a, 9b and 9c.

FIGS. 9a, 9b and 9c illustrate an alternative embodiment of an illuminated golf flagpole 10 which provides a portable remote control device 270, such as a GPS receiver, through which a golfer receives data from a range finder 240, shown in FIGS. 6 and 7, regarding distance of such golfer from such illuminated golf flagpole 10, or from an anemometer 280 or a wind direction detector 290, as illustrated in FIGS. 10a and 10b.

FIGS. 10a and 10b illustrate an alternative embodiment of an illuminated golf flagpole having an anemometer 280 and a wind direction detector 290, comprising a transmitter, mounted to a flagpole tube 20. Said anemometer 280, also comprising a transmitter, is mounted to said flagpole tube in such a position so as to transmit information about wind direction and speed at the pin to a golfer at each hole using such remote control device 270 or remote receiver.

### Operation:

As shown in some detail in FIG. 1, the present device 10 is designed to fit into a golf cup insert 40 residing in a hole on a golf course green. A user places a flagpole tube 20 (shown in FIGS. 1, 2a and 2b) coated with electroluminescent film 30 (shown in FIGS. 1, 2a and 2b) into a milled aluminum stem 50 as shown in FIGS. 1, 2a and 2b. Said film-coated flagpole tube 20 (shown in FIGS. 1, 2a and 2b) is illuminated when said golf flagpole tube 20 makes contact with said milled aluminum stem 50 (shown in FIGS. 1, 2a and 2b) charged by power from a rechargeable battery 80 as shown in FIGS. 1 and 3b. Upon removal of flagpole tube 20 (shown in FIGS. 1, 2a, 2b and 2c) from said milled aluminum stem 50 (shown in FIGS. 1, 2a, 2b, and 2c), flagpole tube 20 ceases to be illuminated until it is reconnected with a charged milled aluminum stem 50.

Using an alternative embodiment having LEDs 210 externally mounted to a flagpole tube 20 and internally stored rechargeable nickel-cadmium batteries 260 for a power source, a user begins by removably affixing said flagpole tube 20 to a flagpole pin 205 by placing an adapter 204 located at a lower end 207 of said flagpole tube 20 over said flagpole pin 205 as shown in FIG. 6. LEDs are illuminated at such time said rechargeable nickel-cadmium batteries 260 are charged. Connecting an illuminated golf flagpole 10 to electrical power using a female power socket 230 shown in FIGS. 6 and 7, a user may charge said rechargeable nickel-cadmium batteries 260.

Using an alternative embodiment, a user may receive information regarding such user's distance from an illuminated golf flagpole from a range finder 240 mounted to a flagpole tube 20 (shown in FIGS. 6 and 7) by operation of a remote control device 270 or GPS receiver, as shown in FIGS. 9a, 9b and 9c. Using yet another alternative embodiment, a golfer may receive information regarding wind direction and wind speed at a particular location of an illuminated golf flagpole from an anemometer 280 and a wind direction detector 290 mounted to a flagpole tube 20 (shown in FIG. 10b) by operation of a remote control device 270 or a remote receiver, as shown in FIGS. 10a and 10b.

What is claimed is:

1. An illuminated golf flagpole, comprising:
a tube having a lower end, an upper end, and a length therebetween;
a pin affixed to the lower end of the tube, the pin for removable fit into a golf cup insert;
tube illumination disposed along a length of the tube; and
a power source for the tube illumination.

2. The flagpole of claim 1 further comprising an illumination control in communication with the flagpole.

3. The flagpole of claim 2 wherein the illumination control further comprises a switch for controlling the tube illumination intensity.

4. The flagpole of claim 2 wherein the illumination control further comprises a tilt switch.

5. The flagpole of claim 1 further comprising a plug integrated with the flagpole for receiving external power.

6. The flagpole of claim 1 further comprising:
an anemometer;
a transmitter for transmitting anemometer data;
at least one remote receiver for receiving the transmitted anemometer data;
a wind direction detector;
a transmitter for transmitting wind direction data collected by the wind direction detector; and
at least one remote receiver for receiving the transmission from the wind direction detector transmitter;

7. The flagpole of claim 6 further comprising:
a GPS receiver and transmitting means; and
at least one remote receiving device for receiving the information transmitted by the GPS transmitter.

8. An illuminated golf flagpole, comprising:
a tube having a lower end, an upper end, and a length therebetween;
a pin affixed to the lower end of the tube, the pin for removable fit into a golf cup insert;
a flag removably affixed to the upper end of the tube;
tube illumination disposed along a length of the tube;
a self-contained rechargeable power source for powering the tube illumination; and
an illumination control in communication with the flagpole.

9. The flagpole of claim 8 wherein the self contained power source is integrated with the flagpole.

10. The flagpole of claim 8 wherein the self contained power source is external to the flagpole.

11. The flagpole of claim 8 further comprising:
an anemometer;
a transmitter for transmitting anemometer data;
at least one remote receiver for receiving the transmitted anemometer data;
a wind direction detector;
a transmitter for transmitting wind direction data collected by the wind direction detector; and
at least one remote receiver for receiving the transmission from the wind direction detector transmitter;

12. The flagpole of claim 11 further comprising:
a GPS receiver and transmitting means;
at least one remote receiving device for receiving the information transmitted by the GPS transmitter.

13. An illuminated golf flagpole, comprising:
a tube having a lower end, an upper end, and a length therebetween;
a pin affixed to the lower end of the tube, the pin for removable fit into a golf cup insert;
a flag removably affixed to the upper end of the tube;
tube illumination disposed along a length of the tube;
a self-contained rechargeable power source for powering the tube illumination;
an illumination control in communication with the flagpole;
an anemometer integrated with the flagpole;
a wind direction detector integrated the flagpole;
a transmitter for transmitting the data from the anemometer;
a transmitter for transmitting the data from the wind direction detector; and
at least one remote receiver to receive a transmission from the anemometer and wind direction detector transmitters.

14. An illuminated golf flagpole, comprising:
a tube having a lower end, an upper end, and a length therebetween;
a pin affixed to the lower end of the tube, the pin for removable fit into a golf cup insert;
a flag removably affixed to the upper end of the tube;
tube illumination disposed along a length of the tube;
a self-contained rechargeable power source for powering the tube illumination;
an automatic illumination control integrated with the flagpole;
an GPS receiver integrated with the flagpole;
a GPS transmitter for transmitting the data from the GPS receiver; and
at least one remote receiver to receive a transmission from the GPS transmitter.

15. An illuminated golf flagpole, comprising:
a tube having a lower end, an upper end, and a length therebetween;
a pin affixed to the lower end of the tube, the pin for removable fit into a golf cup insert;
a flag removably affixed to the upper end of the tube;
tube illumination disposed along a length of the tube;
a self-contained rechargeable power source for powering the tube illumination;
an illumination control in communication with the flagpole;
an anemometer integrated with the flagpole;
a wind direction detector integrated the flagpole;
a transmitter for transmitting the data from the anemometer;
a transmitter for transmitting the data from the wind direction detector;
at least one remote receiver to receive a transmission from the anemometer and wind direction detector transmitters.
an GPS receiver integrated with the flagpole;
a GPS transmitter for transmitting the data from the GPS receiver; and
at least one remote receiver to receive a transmission from the GPS transmitter.
